(19) United States
(12) Patent Application Publication
(10) Pub. No.: US 2005/0126694 A1
(43) Pub. Date: Jun. 16, 2005

(54) Protective tape joining method and apparatus using the same as well as protective tape separating method and apparatus using the same

(75) Inventor: Masayuki Yamamoto, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: Nitto Denko Corporation

(21) Appl. No.: 10/972,536

(22) Filed: Oct. 26, 2004

(30) Foreign Application Priority Data
Dec. 15, 2003 (JP) JP2003-416740

(51) Int. Cl. B32B 31/00

(52) U.S. Cl. 156/247; 156/344; 156/300; 156/556; 156/584

(57) ABSTRACT

The protective tape is joined at an optional angle with respect to the recesses formed between the patterns on the surface of the article, which has irregularities and on which patterns as a plurality of chips are formed in a matrix. After that, joining the adhesive tape to the surface of the protective tape at an optional angle with respect to recesses formed between patterns on the surface of the article, and separating the protective tape at an optional angle with respect to the recesses.

### BACKGROUND OF THE INVENTION

(1) Field of the Invention

The present invention relates to a method for joining a protective tape to an article surface having irregularities, and a method for separating the joined protective tape.

(2) Description of the Related Art

Methods of thinning a semiconductor wafer (hereinafter, simply referred to as a wafer) include mechanical and chemical methods such as a grinding method, a polishing method (CMP) and an etching method. The methods are performed after a protective tape is joined to a wafer surface on which a circuit pattern is formed. For example, in the case of performing a process called “back grinding” on a back face of the wafer, the surface of the wafer, to which a protective tape is joined, is suction-held by a chuck table and the back face of the wafer is ground with a grindstone. Since there is a possibility in that circuits formed on the surface side of the wafer are destroyed or get dirty at the time of grinding the back face of the wafer, generally, a protective tape is joined to the surface of the wafer and, then, the grinding process is performed (see, for example, JP-A 2003-115469). The wafer subjected to the back-face processing such as back grinding is diced (cut) into chips. Before the dicing, generally, the protective tape joined to the wafer surface is separated. As a method of separating the protective tape, there is known a method of joining an adhesive tape to a surface of a protective tape, integrating the adhesive tape and a protective tape, and separating the adhesive tape, thereby separating the protective tape from the wafer surface (see, for example, JP-A 2002-124494).

Upon processing a back face of a wafer, in the case where an adhesive tape cannot be uniformly joined since an adhesive for a protective tape is not uniformly applied to irregularities of patterns formed on the wafer surface, water used at the time of back-face processing enters the depressions. In another case, the level of the surface of the adhesive tape as a holding surface becomes non-uniform and the projections are thinned more. It causes a problem such that the process thickness varies in the wafer plane. In order to solve the problem, pressure of a joining roller is increased or a wafer is heated via a chuck table at the time of joining the protective tape. There is also a case that the protective tape is joined so as to fit the irregularities in the surface of a wafer by a combination of those methods.

However, in joining of a protective tape, however, the method of increasing the pressure of a joining roller and the method of heating a wafer are methods of forcefully deforming the protective tape itself and joining the deformed protective tape. There is a case such that, after the wafer is thinned, a warp of the wafer increases due to the influence of residual stress accumulated on the protective tape.

In the case of joining a protective tape by simply applying high pressure on the joining roller upon joining a protective tape, the force of pressing the roller and the force of rotating the roller are applied. It may cause a problem such that rubber of the joining roller is deformed and damage on the rubber becomes severe.

Further, in recent years, back-face processing on a wafer on which bumps are formed such as a flip chip is in increasing trend and a step between irregularities on the surface of a wafer is becoming larger. Consequently, a protective tape joining method capable of handling the step is demanded.

In the case of separating a protective tape joined to the surface having a large step, for example, if the protective tape is separated by the method disclosed in JP-A 2002-124494, the irregularities formed on an article surface becomes resistance at the time of separating, so that an adhesive tape is not smoothly separated. It also causes a problem such that the adhesive remains around the irregularities.

### SUMMARY OF THE INVENTION

The present invention has been achieved by paying attention to such circumstances and its object is to provide a protective tape joining method and a protective tape separating method capable of joining a protective tape so as to be fit even to irregularities formed on the surface of an article and, further, separating the joined protective tape without leaving a residue of an adhesive and the like around the irregularities.

In order to achieve the above object, the present invention employs the following configuration:

A protective tape joining method for joining a protective tape to a surface of an article, which has irregularities and on which patterns as a plurality of chips are formed in a matrix, the method comprising the step of:
joining the protective tape at an optional angle with respect to the recesses formed between the patterns on the surface of the article.

According to the protective tape joining method of the present invention, when the protective tape is joined at an optional angle with respect to the recesses formed between the patterns on the surface of an article, the adhesive of the protective tape which is joined while being pressed is spread radially toward the recesses. As a result, the protective tape can be joined so as to be fit to the irregularities in a state where the adhesive is applied reliably and uniformly around the irregularities formed on the surface of the article. Herein, the article may be a semiconductor wafer, a lead frame, a printed board and the like. The recess corresponds to a dicing line along which the article is diced. The shape of each of the patterns which will become chips and are formed in the surface of the article is not limited to a square but may be a rectangle.

In the protective tape joining method according to the present invention, preferably, the protective tape is joined from a corner of the chip on the surface of the article or the joining angle of the protective tape with respect to the recesses is an angle at which the direction of joining the protective tape is almost the same as a diagonal line of each of the chips on the surface of the article.

According to this method, even in the case where irregularities are formed on the surface of an article, the adhesive of the protective tape joined while being pressed is applied radially toward the recesses. Consequently, the protective tape can be joined so as to be fit to the irregularities in a state where the adhesive is applied reliably and uniformly around the irregularities.

Examples of the protective tape to be joined to an article may include a protective tape-having a strip shape, which is joined to an article and, then, is cut, and a protective tape which is of a label type having almost the same shape as that of the article.

In order to achieve the above object, the present invention also employs the following configuration:

A protective tape joining apparatus for joining a protective tape to a surface of an article, which has irregularities and on which patterns as a plurality of chips are formed in a matrix, the apparatus comprising:
a transport mechanism for transporting the article to a predetermined process;
an alignment stage for aligning the article so that the adhesive tape is joined to the article at an optional angle with respect to the recesses formed between the patterns on the surface of the article;
a chuck table for holding the aligned article;
a tape supply unit for supplying a strip-shaped protective tape toward the held article;
tape joining means for joining the supplied protective tape to the article;
a tape cutting mechanism for cutting the protective tape joined to the article in a predetermined shape;
tape separating means for separating the cut-out protective tape which becomes unnecessary; and
a tape collector for collecting the separated unnecessary protective tape.

According to the protective tape joining apparatus of the present invention, an article transported by the transport mechanism is mounted on the alignment stage and aligned so that an adhesive tape can be joined at an optional angle. After that, in a state where the article is suction-held by the chuck table, the strip-shaped protective tape is joined to the article at an optional angle, and the protective tape is cut in a predetermined shape. The cut-out unnecessary protective tape is separated and collected, thereby completing joining of the protective tape to the article. With this configuration, when the protective tape is joined at an optional angle with respect to the recesses formed between the patterns on the surface of the article, the adhesive of the protective tape which is joined while being pressed is spread radially toward the recesses. As a result, the protective tape can be joined so as to be fit to the irregularities in a state where the adhesive is applied reliably and uniformly around the irregularities formed on the surface of the article.

In order to achieve the above object, the present invention also employs the following configuration:

A protective tape joining apparatus for joining a protective tape to a surface of an article, which has irregularities and on which patterns as a plurality of chips are formed in a matrix, the apparatus comprising:
a transport mechanism for transporting the article to a predetermined process;
an alignment stage for aligning the article so that the adhesive tape is joined to the article at an optional angle with respect to the recesses formed between the patterns on the surface of the article;
a chuck table for holding the aligned article;
a tape supply unit for supplying a label-type protective tape having an almost same shape as that of the article toward the held article; and
tape joining means for joining the supplied protective tape to the article.

According to the protective tape joining apparatus of the present invention, an article transported by the transport mechanism is mounted on the alignment stage and aligned so that an adhesive tape can be joined at an optional angle. After that, in a state where the article is suction-held by the chuck table, the protective tape of the label type having the shape almost the same as that of the article is joined to the article at the optional angle. Therefore, with this configuration, the protective tape is joined at the optional angle with respect to the recesses formed between the patterns on the surface of the article. Consequently, the adhesive of the protective tape which is joined while being pressed is spread radially toward the recesses. As a result, the protective tape can be joined so as to be fit to the irregularities in a state where the adhesive is applied reliably and uniformly around the irregularities formed on the surface of the article.

In order to achieve the above object, the present invention also employs the following configuration:

A protective tape separating method for joining an adhesive tape to the surface of the protective tape joined according to the method of claim 1, and separating the protective tape from the article by separating the adhesive tape, the method comprising the step of:
joining the adhesive tape to the surface of the protective tape at an optional angle with respect to recesses formed between patterns on the surface of the article, and separating the protective tape at an optional angle with respect to the recesses.

According to the protective tape separating method of the present invention, the protective tape is separated at an optional angle with respect to the recesses formed on the surface of an article, so that the separating start point and the recesses formed between the patterns as chips do not coincide with each other. Thus, since the protective tape is not retained by the recesses on start of separating the protective tape, the adhesive of the protective tape is not left in the recesses.

In the protective tape separating method according to the present invention, preferably, the protective tape is separated from a corner of the chip on the surface of the article or the separating angle of the protective tape is an angle at which the direction of separating the protection tape is almost the same as a diagonal line of each of the chips on the surface of the article.

By separating the protective tape from a corner of the chip on the surface of the article or by making the direction of separating the protective tape almost the same as the diagonal line of each of the chips, the contact area in the separating start portion of the protective tape in each chip can be reduced. Consequently, the separating resistance can be reduced. For example, even if projections such as bumps are formed on the surface of the chip, the protective tape can be smoothly separated without leaving the adhesive of the protective tape and the like on the surface of the chip.

In order to achieve the above object, the present invention also employs the following configuration:

A protective tape separating met-hod for joining an adhesive tape to a protective tape joined to a surface of an article on which patterns as a plurality of chips are formed in a matrix, and separating the protective tape from the article by separating the adhesive tape, the method comprising the step of:
separating the adhesive tape in a direction which is almost the same as the diagonal line of the chip.

According to this method, the adhesive tape is disposed so that the direction of separating the adhesive tape coincides with the diagonal line of the semiconductor chip formed on the surface of the article. After that, by separating the adhesive tape, the protective tape is removed. Consequently, when the separating resistance is the highest on start of separating the adhesive tape, the contact area between the adhesive tape and the semiconductor chip can be reduced, and the separating resistance on start of separating can be suppressed to be low.

In order to achieve the above object, the present invention also employs the following configuration:

A protective tape separating method for joining an adhesive tape to a protective tape joined to a surface of an article on which patterns as a plurality of chips are formed in a matrix, and separating the protective tape from the article by separating the adhesive tape, the method comprising the step of:
separating the adhesive tape from a corner of the chip.

According to this method, the adhesive tape is disposed so that the direction of separating the adhesive tape coincides with the diagonal line of the semiconductor chip formed on the surface of the article. After that, by separating the adhesive tape, the protective tape is removed. Consequently, when the separating resistance is the highest on start of separating the adhesive tape, the contact area between the adhesive tape and the semiconductor chip can be reduced, and the separating resistance on start of separating can be suppressed to be low.

In order to achieve the above object, the present invention also employs the following configuration:

A protective tape separating apparatus for joining an adhesive tape to a protective tape joined to a surface of an article on which patterns as a plurality of chips are formed in a matrix, and separating the protective tape from the article by separating the adhesive tape, the apparatus comprising:
a separating table for suction-holding the article to which the protective tape is joined;
detecting means for detecting an optional angle with respect to a recess formed between patterns in the surface of the article;
turning means for turning the separating table so as to be aligned in a predetermined position on the basis of the detected optional angle;
adhesive tape joining means for joining the adhesive tape to the surface of the aligned article; and
separating means having an edge for separating the adhesive tape integrally with the protective tape from the article to which the adhesive tape is joined.

The optional angle with respect to the recess formed between the patterns on the article suction-held by the separating table is detected by the detecting means. On the basis of the detection result, the separating table is turned in the predetermined position. After that, the adhesive tape is joined to the surface of the article by the adhesive tape joining means, and the adhesive tape is separated integrally with the protective tape by the edge. With this configuration, the direction of separating the adhesive tape is set to the optional angle with respect to the recess formed between the patterns and the adhesive tape and the protective tape are integrally separated. Thus, the contact area between the adhesive tape and the semiconductor chip can be reduced when the separating resistance on start of separating the adhesive tape becomes the highest, and the separating resistance on start of separating can be suppressed to be low.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 illustrates the positional relation between a protective tape and a wafer for describing a protective tape joining method according to the present invention;

FIG. 2 is a schematic perspective view showing an example of an apparatus used for the protective tape joining method according to the present invention;

FIGS. 3 to 6 illustrate the protective tape joining method;

FIG. 7 is a schematic diagram showing a main part of an example of an apparatus used for a protective tape separating met-hod according to the present invention;

FIGS. 8 and 9 illustrate the protective tape separating method;

FIGS. 10A and 10B illustrate the positional relation between an adhesive tape for separating the protective tape and a wafer, and show states before and after turn of a separating table which is turned by separating table rotating means; and

FIG. 11 is a schematic perspective view showing an embodiment of a mounting/separating apparatus including, in a part, a protective tape separating apparatus of the embodiment used for the protective tape separating method according to the present invention.

### DESCRIPTION OF THE PREFERRED EMBODIMENTS

An embodiment of the present invention will be described below with reference to the drawings.

In the following embodiment, a wafer will be described as an example of an article. An article having irregularities on a surface to which a protective tape according to the present invention is joined is not limited to a wafer. For example, the article may be a lead frame, various printed boards, or the like. Therefore, the present invention is not limited to the following embodiment.

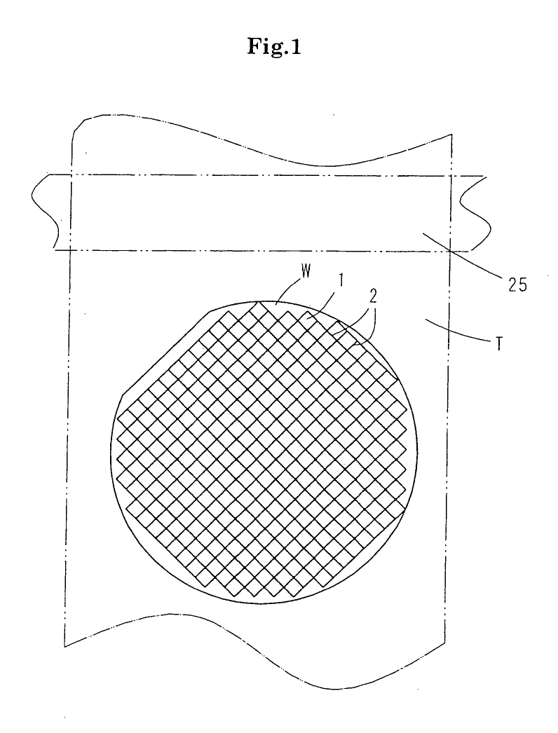

In a method of joining a protective tape according to the present invention, as shown in FIG. 1, the direction of joining a protective tape T is set not to be the same as that of recesses 2 corresponding to dicing lines between patterns 1 which are formed on a wafer W and are to become chips after dicing. That is, the method is characterized by joining the protective tape 1 at an optional angle. It is preferable to join the protective tape T so that the joining direction almost coincides with the diagonal line of each of the patterns 1 as chips. As an apparatus for joining the protective tape T onto the surface of the wafer W, a known protective tape joining apparatus can be applied.

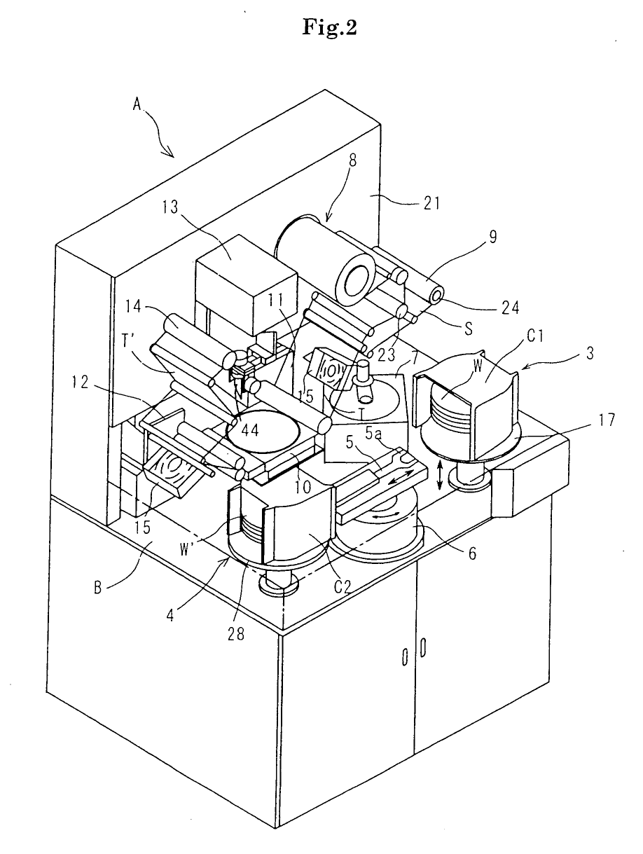

FIG. 2 is a schematic perspective view showing an embodiment of a protective tape joining apparatus used for the protective tape joining method according to the present invention. In FIG. 2, a protective tape joining apparatus A has, on the front side of a base B, a wafer supply unit 3 into which a wafer cassette C1 containing therein wafers W each having an orientation flat is loaded, and a wafer collector 4 for collecting processed wafers W′ on each of which the protective tape T is joined and cut out. A wafer transport mechanism 6 having a robot arm 5 is disposed between the wafer supply unit 3 and the wafer collector 4, and an alignment stage 7 is disposed on the right deep side of the base B. A tape supply unit 8 for supplying the protective tape T toward the wafer W is disposed above the alignment stage 7. A separator collector 9 for collecting only a separator S from the protective tape T with the separator supplied from the tape supply unit 8 is disposed off to the lower right of the tape supply unit 8. On the left side of the alignment stage 7, a chuck table 10 on which the wafer W is mounted and suction-held, a tape joining means 11 for joining the protective tape T to the wafer W held on the chuck table 10, and a tape separating means 12 for separating an unnecessary tape T′ which is left after the protective tape T is joined to the wafer W and then is cut out are disposed. Above the alignment stage 7, a tape cutting mechanism 13 for cutting the protective tape T joined on the wafer W along the outer shape of the wafer W is provided. Above the left side of the base B, a tape collector 14 for winding up the unnecessary tape T′ separated by the tape separating means 12 is disposed. Static eliminators 15 for eliminating static electricity from the protective tape T to be joined to the wafer W and the unnecessary tape T′ before being collected are disposed so as to sandwich the chuck table 10.

A method of joining the protective tape T by the protective tape joining apparatus A constructed as described above will now be described.

When the wafer cassette C1 in which the wafers W are contained in multiple stages is mounted on a cassette stand 17 of the wafer supply unit 3, the cassette stand 17 turns and stops in a position where the wafer W to be taken out can be taken out by the robot arm 5.

After that, the wafer transport mechanism 6 turns, a wafer holder 5a of the robot arm 5 is inserted between wafers in the wafer cassette C1, and the robot arm 5 suction-holds the wafer W from the back-face side (under face) by the wafer holder 5a, and transfers the wafer W onto the alignment stage 7.

The wafer W mounted on the alignment stage 7 is aligned on the basis of its orientation flat. The aligned wafer W is suction-held again by the robot arm 5, transported, and transferred onto the chuck table 10.

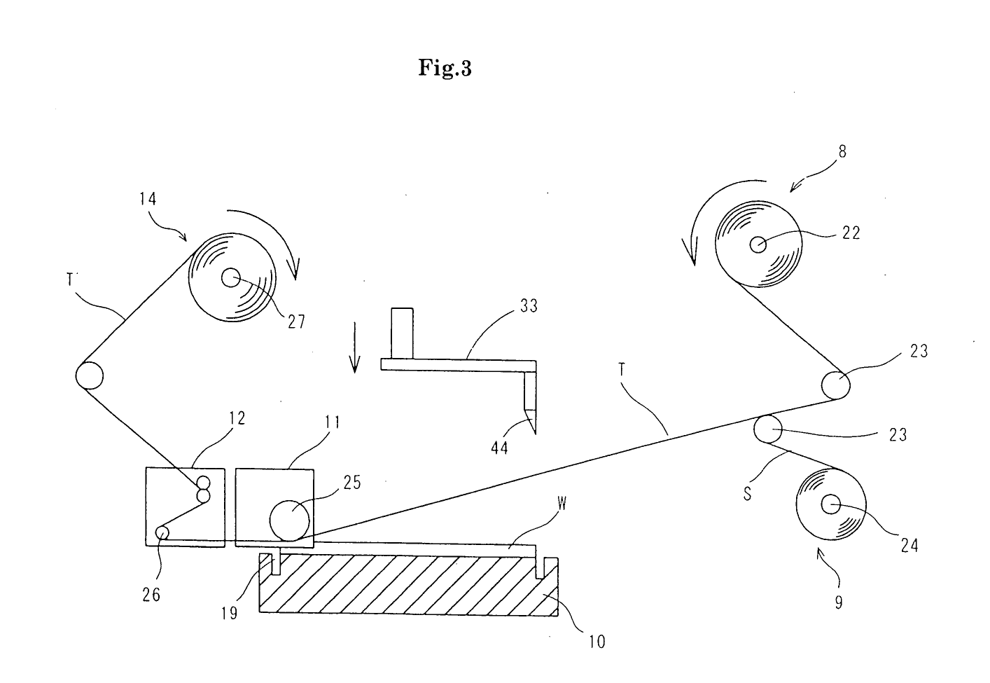

The wafer W mounted on the chuck table 10 is positioned so that its center coincides with the center of the chuck table 10 and suction-held. The chuck table 10 is turned by an optional angle so that, as shown in FIG. 1, the direction of joining the protection table T shown by the arrow and the diagonal line of the pattern 1 as a chip formed in the wafer W almost coincide with each other. Alternatively, upon mounting the wafer W on the chuck table 10, it can be mounted in advance so that the direction of joining the protective tape T and the diagonal line of the chip become almost the same. At this time, as shown in FIG. 3, the tape joining means 11 and the tape separating means 12 wait in initial positions on the left side, and a cutter unit 33 of the tape cutting mechanism 13 stands by in an upper initial position.

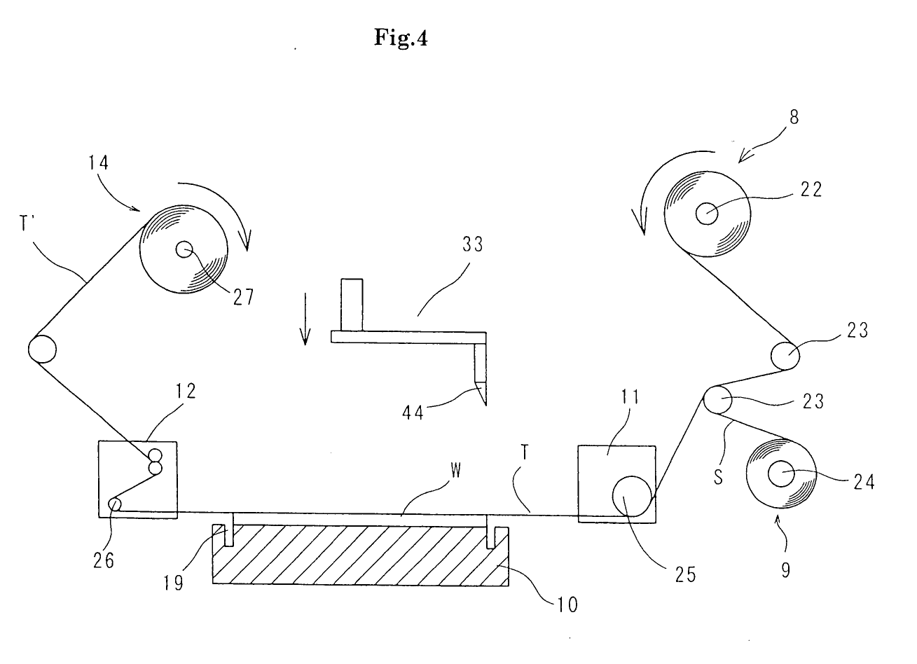

After alignment of the wafer W, as shown in FIG. 4, a joining roller 25 of the tape joining means 11 is moved downward and allowed to roll on the wafer W while pressing the protective tape T downward in the direction opposite to the tape travel direction (from left to right in FIG. 4), thereby uniformly joining the protective tape T onto the whole surface of the wafer W. When the tape joining means 11 reaches a terminating position, the joining roller 25 is moved upward. Since the direction of joining the protective tape T and the diagonal line of the chip formed on the surface of the wafer W are almost the same, when the joining roller 25 rolls, the axial direction of the joining roller 25 and the direction of the recess 2 on the surface of the wafer W do not become the same. When the protective tape T is pressed by the joining roller 25, the protective tape T is joined reliably in the recess 2. As described above, the protective tape T is joined onto the surface of the wafer W so as to be closely fit to the irregularities on the surface of the wafer W without generating air bubbles between the protective tape T and the surface of the wafer W.

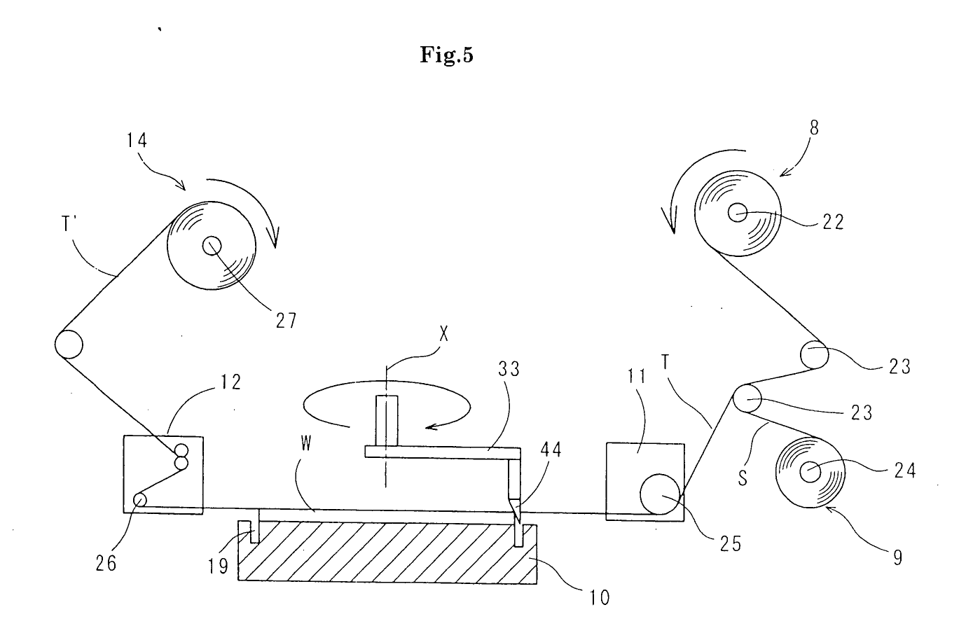

Subsequently, the tape cutting mechanism 13 is driven to move downward and, as shown in FIG. 5, the cutter unit 33 waiting above moves downward to the cutting position. A cutter blade 44 is stuck through the protective tape T and stops at a preset level. When the cutter blade 44 stops at the preset level, the cutter blade 44 turns and the protective tape T is cut along the shape of the wafer W.

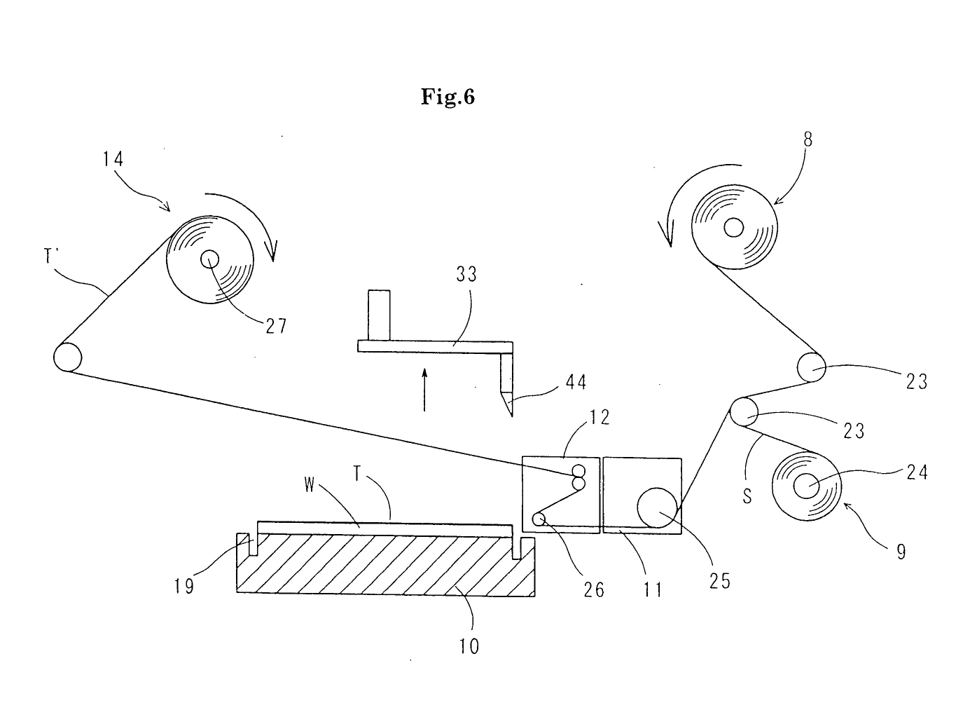

After the tape is cut along the shape of the wafer W, as shown in FIG. 6, the cutter unit 33 is moved upward to the original standby position. The tape separating means 12 winds up and separates the unnecessary tape T′ remained after the cutting along the wafer W while traveling above the wafer W in the direction opposite to the tape travel direction.

When the tape separating means 12 reaches the separating work end position, the tape separating means 12 and the tape joining means 11 move in the tape travel direction and return to the initial positions. At this time, the unnecessary tape T′ is wound around a collecting bobbin 27 and the protective tape T of a predetermined amount is unreeled from the tape supply unit 8. The wafer W having a surface on which the protective tape T is joined is contained in the wafer collector 4 by the robot arm 5. Although the case of joining the protective tape T to the surface of the wafer W and cutting the protective tape T along the shape of the wafer W has been described, a so-called label-type protective tape which is pre-cut along the shape of the wafer W may be used.

The wafer W having a surface on which the protective tape T is joined as described above is moved in a state where it is contained in a wafer cassette C2 to a back-face processing apparatus in the following process, and is subjected to various back-face processings. The protective tape T on the surface of the wafer W subjected to the back-face processing is separated by a separating method which will be described below and the wafer W is moved to a dicing process of dicing the wafer W into semiconductor chips.

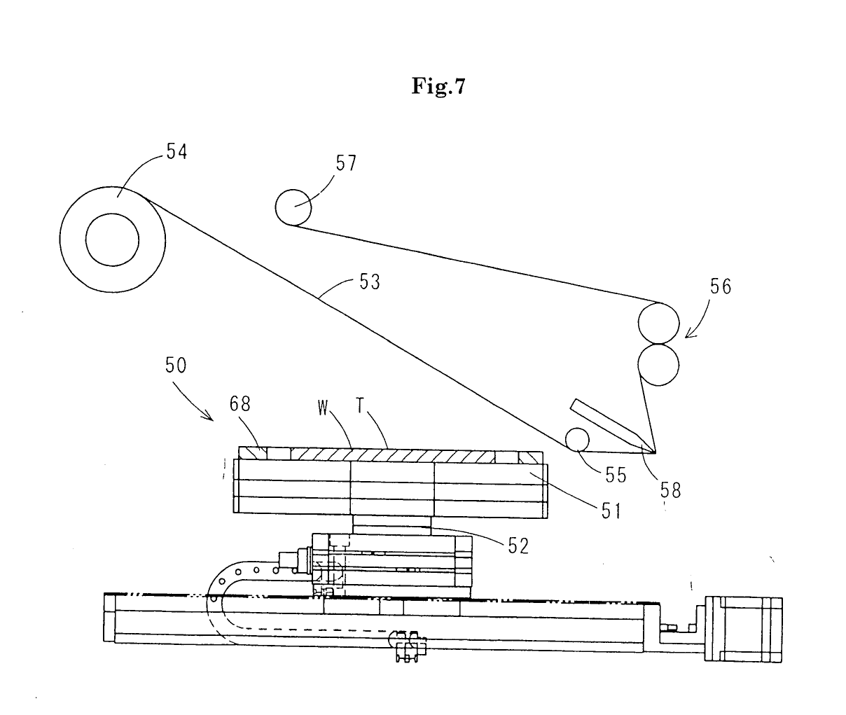

FIG. 7 shows a schematic diagram showing a main part of an embodiment of the protective tape separating apparatus for separating the protective tape T.

A protective tape separating apparatus 50 shown in FIG. 7 includes: a separating table 51 on which the wafer W as an article is mounted; a separating table turning means 52 for turning the separating table 51; a tape supply unit 54 for supplying an adhesive tape 53 for separating the protective tape T protecting the surface of the wafer W; an adhesive tape joining means 55 for joining the adhesive tape 53 to the protective tape T on the surface of the wafer W by traveling along the surface of the wafer W on the separating table 51; an adhesive tape separating means 56 for separating the adhesive tape 53 from an end of the wafer W; and an adhesive tape collecting means 57 for collecting the adhesive tape 53 separated together with the protective tape T on the surface of the wafer W.

The separating table 51 is coupled to an evacuating apparatus (not shown) and can suction-hold the wafer W as an article to be mounted. The separating table 51 is provided with the separating table turning means 52 constructed by a rotation driving system such as a motor and an air cylinder.

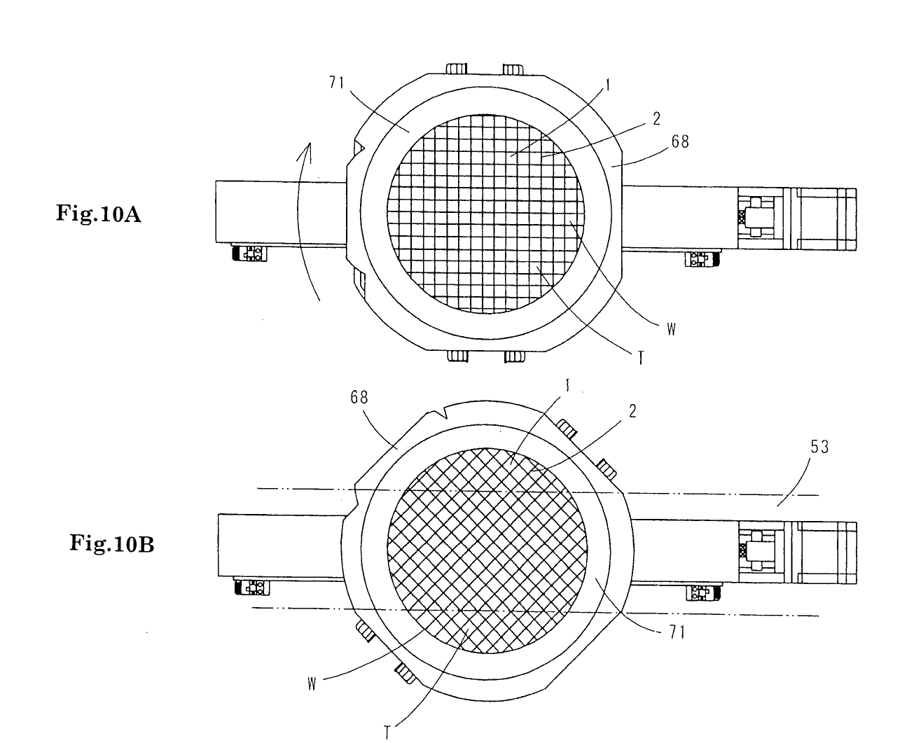

The separating table turning means 52 detects the shape of a pattern by a detecting means (not shown) for detecting the shape of a pattern to become a chip formed on the surface of the wafer W, and performs rotation control so that the diagonal line of each chip (pattern) and the direction of joining/separating the adhesive tape 53 become almost the same (see FIGS. 10A and 10B). An example of the detecting means for detecting the shape of a semiconductor chip is a CCD camera or the like.

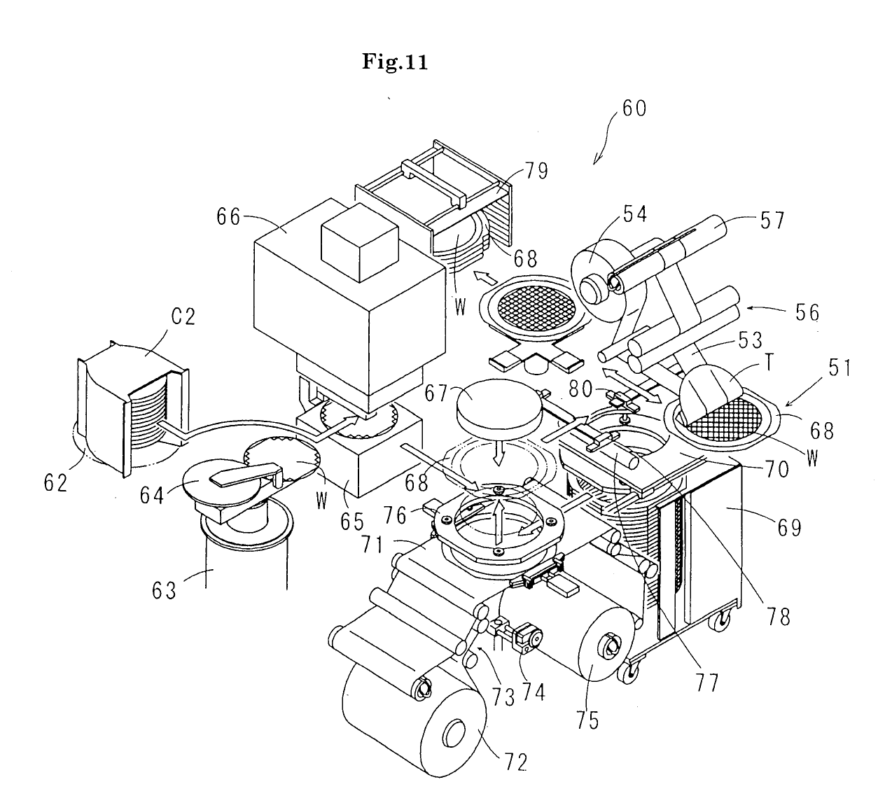

An example of a mounting/separating apparatus 60 including the protective tape removing apparatus 50 having the above configuration, and mounting the wafer W onto a ring frame for dicing as the subsequent process will be described with reference to FIG. 11.

As shown in FIG. 11, the mounting/separating apparatus 60 includes: a wafer supply unit 62 into which the wafer cassette C2 containing therein a stack of the wafers W on which the back-face processing has been completed is loaded; a wafer transport mechanism 63 having a robot arm which bends and swings; a wafer pressing mechanism 64 for correcting a warped wafer W to be flat; an alignment stage 65 for aligning the wafer W; an ultraviolet ray irradiating unit 66 for irradiating the surface protective tape T with ultraviolet rays; a wafer chuck table 67 as a holding member for suction-holding the wafer W and chucking the wafer W; a ring frame supply unit 69 to which a ring frame 68 is loaded; a ring frame transport mechanism 70 for transferring the ring frame 68; a dicing adhesive tape supply unit 72 for supplying an adhesive tape 71 for dicing; a dicing adhesive tape joining means 73 for joining the adhesive tape 71 for dicing; a dicing adhesive tape cutting unit 74 for cutting the adhesive tape 71 for dicing; a dicing adhesive tape collector 75 for collecting the cut adhesive tape 71 for dicing; a ring frame lifting mechanism 76 for moving upward/downward the ring frame 68 to which the adhesive tape 71 for dicing is joined; a wafer mounting mechanism 77 for joining the wafer W to the adhesive tape 71 for dicing is joined to the ring frame 68; a ring frame transport mechanism 78 for transferring the ring frame for wafer mounting; the apparatus 50 for separating the protective tape of the wafer W; a ring frame housing mechanism 80 for containing therein ring frames; and a ring frame collector 79 into which a cassette for containing therein a stack of processed ring frames is loaded.

The wafer supply unit 62 contains the wafers W which are in the horizontal posture with the surface on which the protective tape T is joined facing upward and are inserted in the cassette at proper intervals in the vertical direction, and loads the cassette onto a cassette stand. The ring frame collector 79 similarly contains the ring frames 68 on which the wafers W subjected to the protective tape separating process are mounted in the ring frame cassette at proper intervals in the vertical direction, and loads the cassette onto a cassette stand.

The robot arm of the wafer transport mechanism 63 is movable in the horizontal direction and swingable, unloads the wafer W from the wafer supply unit 62, and supplies the wafer W onto the alignment stage 65.

When the wafer W supplied onto the alignment stage 65 cannot be suction-held due to its warp, the wafer pressing mechanism 64 presses the wafer W from the surface side to thereby correct the wafer W to be flat, and the wafer W is suction-held by the alignment stage 65.

The alignment stage 65 aligns the wafer W on the basis of detection of the orientation flat, notch or the like of the wafer W. In the case where the surface protective tape T joined to the surface of the wafer W is an ultraviolet-curing adhesive tape, ultraviolet rays are emitted from the ultraviolet ray irradiating unit 66 disposed above the alignment stage 65. By the ultraviolet ray irradiation, the adhesion of the surface protective tape T decreases and the surface protective tape T can be easily separated.

After that, the wafer W corrected to be flat is transferred from the alignment stage 65 to the wafer chuck table 67 as a holding member.

The wafer chuck table 67 is coupled to an evacuating means (not shown) or the like and can suction-hold the wafer W. In place of the evacuating apparatus, a Bernoulli's chuck for holding the wafer W by the ejector effect by using an air blow can be used.

The ring frame supply unit 69 contains a stack of ring frames 68 positioned in a predetermined direction in a wagon. The ring frame transport mechanism 78 suction-holds and transfers the ring frame 68.

The dicing adhesive tape supply unit 72 leads the adhesive tape 71 for deriving from an original roll so as to pass below the ring frame 68 to the dicing adhesive tape joining means 73 and the dicing adhesive tape collector 75. The adhesive tape 71 for dicing which is wider than the diameter of the ring frame 68 is used.

The dicing adhesive tape joining unit 73 joins the adhesive tape 71 for dicing to the ring frame 68 and the dicing adhesive tape cutting unit 74 cuts the adhesive tape 71 for dicing on the ring frame 68. The dicing adhesive tape collector 75 collects the cut-out unnecessary adhesive tape 71 for dicing.

The ring frame lifting mechanism 76 as a component of a joining mechanism for joining the adhesive tape 71 for dicing joined to the ring frame 68 to the wafer W moves the ring frame 68 to which the adhesive tape 71 for dicing is joined in the vertical direction. The ring frame lifting mechanism 76 performs wafer mounting for moving upward the ring frame 68 to which the adhesive tape 71 for dicing is joined from below of the back-face side of the wafer W to join the wafer W and the adhesive tape 71 for dicing joined to the ring frame 68 each other, thereby integrating the wafer W and the ring frame 68.

The ring frame transport mechanism 78 suction-holds in vacuum the ring frame 68 integrated with the wafer W joined to the adhesive tape 71 for dicing and transfers it onto the separating table 51 of the protective tape separating apparatus 50.

The ring frame housing mechanism 80 suction-holds in vacuum and transfers the ring frames 68 and prepares for containing the ring frames 68 into the ring frame collector 79.

Next, the process of the protective tape separating method using the mounting/separating apparatus 60 having the above configuration will be described with reference to the drawings.

The robot arm of the wafer transport mechanism 63 suction-holds one contained wafer W with its surface on which a pattern is formed facing upward from the wafer cassette C2 of the wafer supply unit 62 and transfers it onto the alignment stage 65. The suction state of the wafer W is checked and, if the flatness of the wafer W is poor and the suction state is bad due to a warp or the like, the wafer W is corrected to be flat by the wafer pressing mechanism 64. The wafer W is suction-held in the corrected state. On the basis of detection of an orientation flat, a notch or the like of the wafer W, the wafer W is aligned. After that, in the case where the surface protective tape T joined to the wafer W is of the ultraviolet curing type, ultraviolet ray irradiating process is performed on the alignment stage 65.

The alignment stage 65 moves to a position below the wafer chuck table 67 and transfers the aligned wafer W onto the wafer chuck table 67 while holding the flat state.

On the other hand, the stacked ring frames 68 are suction-held one by one from the top of the ring frame supply unit 69 and transferred to the joining position of the adhesive tape 71 for dicing.

The adhesive tape 71 for dicing is joined and, after that, cut on the ring frame 68. The cut-out unnecessary adhesive tape 71 for dicing is wound up and the ring frame 68 to which the adhesive tape 71 for dicing is joined is produced.

Subsequently, the ring frame 68 to which the adhesive tape 71 for dicing is joined is moved upward from below the wafer W by the ring frame lifting mechanism 76. Since the ring frame 68 is disposed facing the wafer W in a posture slightly inclined relative to the wafer W, the adhesive tape 71 for dicing is joined from an end of the wafer W as the ring frame 68 is moved upward. In such a manner, the wafer mounting of integrating the wafer W and the ring frame 68 is performed. The ring frame mounted on the wafer will be referred to as a mounted frame.

The ring frame (mounted frame) 68 integrated with the wafer W is transferred to the separating table 51 of the protective tape separating apparatus 50 in order to separate the surface protective tape 20 on the wafer W and is suction-held.

As enlargedly shown in FIG. 7, the shape of each of the patterns 1 (see FIG. 1) as chips which are formed in the wafer W and the recesses 2 as dicing lines formed between the patterns are detected by a detecting means (not shown) such as a CCD camera, and the mounted frame 68 integrated with the wafer W mounted on the separating table 51 is turned by the joining table turning means 52 so that the diagonal line of the pattern 1 and the feed direction of the adhesive tape 53 coincide with each other.

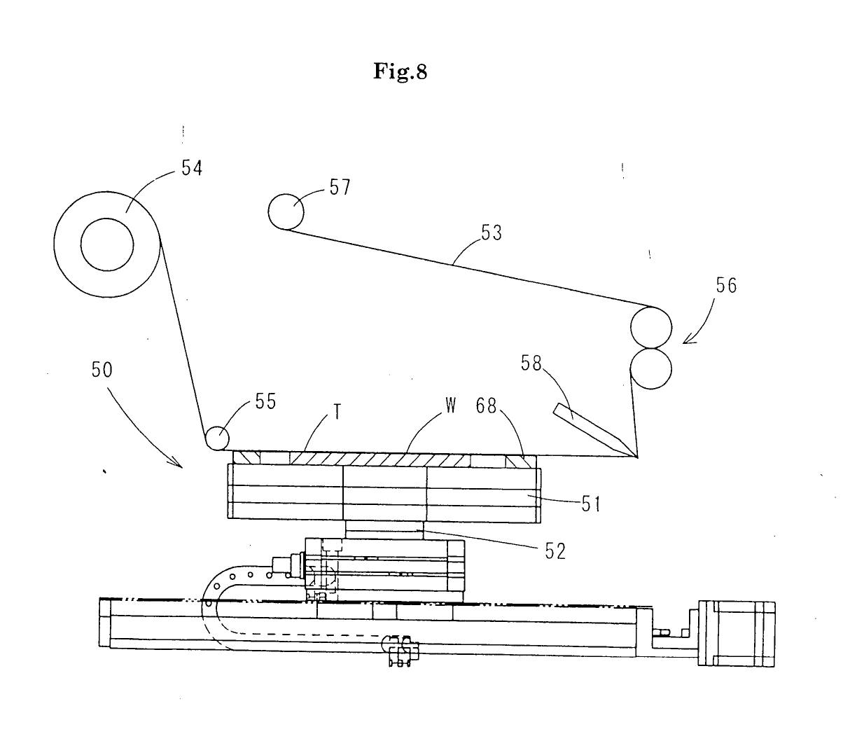

As shown in FIG. 10B, the mounted frame 68 is turned so that the diagonal line of the chip (pattern) 1 and the feed direction of the adhesive tape 53 coincide with each other, in other words, the mounted frame 68 is turned so that the recesses 2 and the feed direction of the adhesive tape 53 cross each other. After that, as shown in FIG. 8, the roller of the adhesive tape joining means 55 travels along the surface of the wafer W, thereby joining the adhesive tape 53 onto the protective tape T on the surface of the wafer W.

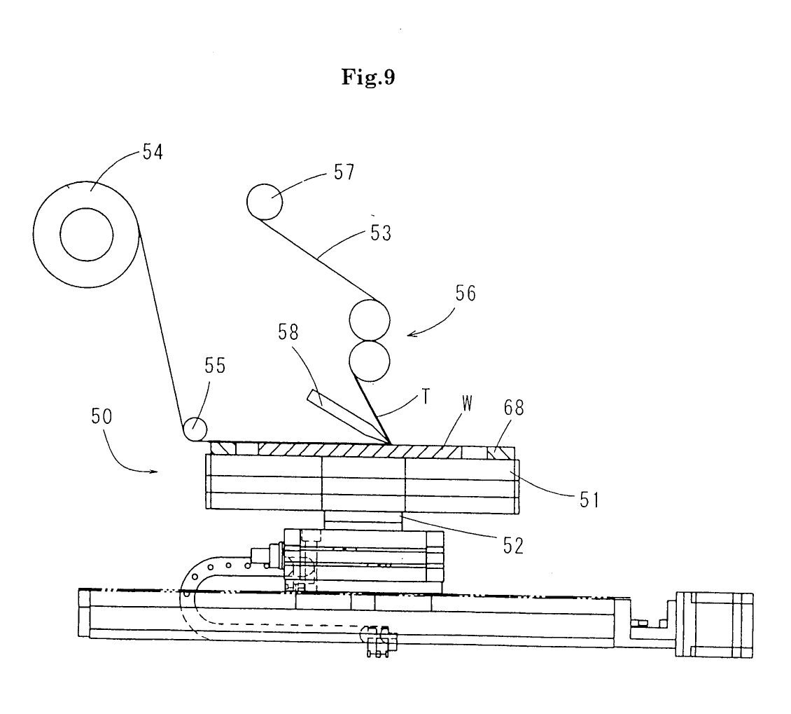

As shown in FIG. 9, the adhesive tape separating means 56 travels forward, the front end of an edge member 58 travels while pressing the adhesive tape 53 against the surface of the protective tape T, the adhesive tape collecting means 57 rotates at peripheral velocity which is tuned with the travel speed, and the protective tape T integrated with the adhesive tape 53 is separated from the wafer W.

Since the direction of separating the adhesive tape 53 and the diagonal line of the chip (pattern) 1 in the surface of the wafer W are almost the same, the separation start portion of the protective tape T joined to the surface of the wafer W, that is, the surface of the chip 1 becomes smaller, so that separating resistance can be suppressed at the time of start of separating when separating resistance is the highest. Consequently, the protective tape T can be removed without leaving the adhesive of the protective tape T on the surface. As shown in FIG. 10B, the separating direction of the adhesive tape 53 and the recesses 2 formed between the chips (patterns) 1 do not cross each other at right angles. Thus, at the time of separating the adhesive tape 53, the adhesive tape 53 can be smoothly separated.

After that, the ring frames (mounted frames) 68 are contained one by one into the ring frame collector 79.

For example, when the protective tape T is not joined, in a manner similar to the protective tape separating method, an unnecessary thing such as a resist used for forming the patterns 1 and the like can be also removed by joining the adhesive tape 53 directly onto the surface of the wafer W and then separating the adhesive tape 53. In this case as well, by joining and separating the adhesive tape 53 so that the direction becomes almost the same as the diagonal line of the chips (patterns) 1, separating resistance acting at the time of separating the adhesive tape 53 can be reduced and the influence on the chips can be suppressed.

The method of joining/separating a protective tape according to the present invention is executed as described above. Even in the case where projections such as bumps and recesses such as dicing lines are formed in the surface of chips, a protective tape is joined along the diagonal line of the chips (patterns). Consequently, even when irregularities as dicing lines are formed, the protective tape can be joined so as to be closely fit along the irregularities. Further, also at the time of separating the protective tape, separating resistance can be reduced. Thus, even in the case where the surface has irregularities, a protective tape can be smoothly separated.

The present invention may be embodied in other specific forms without departing from the spirit or essential attributes thereof and, accordingly, reference should be made to the appended claims, rather than to the foregoing specification, as indicating the scope of the invention.

1. A protective tape joining method for joining a protective tape to a surface of an article, which has irregularities and on which patterns as a plurality of chips are formed in a matrix, the method comprising the step of:
joining the protective tape at an optional angle with respect to the recesses formed between the patterns on the surface of the article.

2. The protective tape joining method according to claim 1, wherein
the protective tape is joined from a corner of the chip on the surface of the article.

3. The protective tape joining method according to claim 1, wherein
the joining angle of the protective tape with respect to the recesses is an angle at which the direction of joining the protective tape is almost the same as a diagonal line of each of the chips on the surface of the article.

4. The protective tape joining method according to claim 1, wherein
the protective tape having a strip shape is joined to an article and, then, is cut.

5. The protective tape joining method according to claim 1, wherein
the protective tape is of a label type having almost the same shape as that of the article.

6. A protective tape joining apparatus for joining a protective tape to a surface of an article, which has irregularities and on which patterns as a plurality of chips are formed in a matrix, the apparatus comprising:
a transport mechanism for transporting the article to a predetermined process;
an alignment stage for aligning the article so that the adhesive tape is joined to the article at an optional angle with respect to the recesses formed between the patterns on the surface of the article;
a chuck table for holding the aligned article;
a tape supply unit for supplying a strip-shaped protective tape toward the held article;
tape joining means for joining the supplied protective tape to the article;
a tape cutting mechanism for cutting the protective tape joined to the article in a predetermined shape;
tape separating means for separating the cut-out protective tape which becomes unnecessary; and
a tape collector for collecting the separated unnecessary protective tape.

7. A protective tape joining apparatus for joining a protective tape to a surface of an article, which has irregularities and on which patterns as a plurality of chips are formed in a matrix, the apparatus comprising:
a transport mechanism for transporting the article to a predetermined process;
an alignment stage for aligning the article so that the adhesive tape is joined to the article at an optional angle with respect to the recesses formed between the patterns on the surface of the article;
a chuck table for holding the aligned article;
a tape supply unit for supplying a label-type protective tape having an almost same shape as that of the article toward the held article; and
tape joining means for joining the supplied protective tape to the article.

8. A protective tape separating method for joining an adhesive tape to the surface of the protective tape joined according to the method of claim 1, and separating the protective tape from the article by separating the adhesive tape, the method comprising the step of:
joining the adhesive tape to the surface of the protective tape at an optional angle with respect to recesses formed between patterns on the surface of the article, and separating the protective tape at an optional angle with respect to the recesses.

9. The protective tape separating method according to claim 4, wherein
the protective tape is separated from a corner of the chip on the surface of the article.

10. The protective tape separating method according to claim 4, wherein
the separating angle of the protective tape is an angle at which the direction of separating the protection tape is almost the same as a diagonal line of each of the chips on the surface of the article.

11. A protective tape separating method for joining an adhesive tape to a protective tape joined to a surface of an article on which patterns as a plurality of chips are formed in a matrix, and separating the protective tape from the article by separating the adhesive tape, the method comprising the step of:
separating the adhesive tape in a direction which is almost the same as the diagonal line of the chip.

12. A protective tape separating method for joining an adhesive tape to a protective tape joined to a surface of an article on which patterns as a plurality of chips are formed in a matrix, and separating the protective tape from the article by separating the adhesive tape, the method comprising the step of:
separating the adhesive tape from a corner of the chip.

13. A protective tape separating apparatus for joining an adhesive tape to a protective tape joined to a surface of an article on which patterns as a plurality of chips are formed in a matrix, and separating the protective tape from the article by separating the adhesive tape, the apparatus comprising:
a separating table for suction-holding the article to which the protective tape is joined;
detecting means for detecting an optional angle with respect to a recess formed between patterns in the surface of the article;
turning means for turning the separating table so as to be aligned in a predetermined position on the basis of the detected optional angle;
adhesive tape joining means for joining the adhesive tape to the surface of the aligned article; and
separating means having an edge for separating the adhesive tape integrally with the protective tape from the article to which the adhesive tape is joined.
